(19) United States
(12) Patent Application Publication
(10) Pub. No.: US 2017/0295034 A1
(43) Pub. Date: Oct. 12, 2017

(54) ONBOARD COMMUNICATION NETWORK OF AN AIRCRAFT AND COMMUNICATION SYSTEM

(71) Applicants: AIRBUS OPERATIONS (S.A.S.), Toulouse (FR); AIRBUS (S.A.S.), Toulouse (FR)

(72) Inventors: Jean-François SAINT-ETIENNE, CUGNAUX (FR); Juan LOPEZ, GRENADE (FR)

(21) Appl. No.: 15/476,063

(22) Filed: Mar. 31, 2017

(30) Foreign Application Priority Data
Apr. 11, 2016 (FR) 16 53162

(51) Int. Cl. H04L 12/46; H04L 29/08

(52) U.S. Cl. CPC H04L 12/4641; H04L 67/12

(57) ABSTRACT

An onboard communication network of an aircraft and communication system. The onboard communication network of an aircraft is a deterministic switched Ethernet network including a set of subscribers and at least one switch. It uses virtual links, each defined between a transmitting subscriber and one or more receiving subscribers. The at least one switch includes a communication port configured for communicating with at least one equipment external to the aircraft; and the communication network is configured such that at least one of the virtual links is transmitted though this communication port so as to transmit the information exchanged between subscribers to the network to the equipment external to the aircraft by the virtual link

### CROSS-REFERENCE TO RELATED APPLICATION

This patent application claims the benefit of and priority to French patent application number FR 16 53162, filed on Apr. 11, 2016, the entire disclosure of which is incorporated by reference herein.

### TECHNICAL FIELD

The disclosure herein relates to the field of communication networks installed in aircraft.

### BACKGROUND

Aircraft generally comprise one or more onboard communication networks provided for allowing communications between onboard equipment, in particular onboard computers. In order to meet the regulation requirements with regard to certification of aircraft, an onboard communication system must be deterministic, that is to say it must allow a transmission of information from a transmitting equipment subscribed to that communication system to one or more pieces of receiving equipment subscribed to that communication network, with a transmission time less than a predetermined time as well as a guarantee of non-loss of information through the network. The ARINC 664 part 7 standard defines a deterministic onboard avionics communication system, based on a full-duplex Ethernet technology. Such a network can for example correspond to an AFDX® communication network. In a network conforming to the ARINC 664 part 7 standard, each equipment subscribed to the network is connected to a network switch and the communications between the different subscribed equipment use virtual links predefined during the definition and configuration of the network. A virtual link is defined between a transmitting subscriber and one or more receiving subscribers, via one or more network switches. Each virtual link uses a determined path in the network. A bandwidth is allocated to each virtual link and the routing of the different virtual links of the network is carried out in such a way that the sum of the bandwidths allocated to the virtual links using a same physical link does not exceed the bandwidth supported by the physical link. All of the communications between subscribers are defined in advance, by the definition of the virtual links, in order to allow a configuration of the switches: each switch comprises a configuration table as a function of the virtual links passing through that switch. This configuration table notably comprises switching information relative to the routing of the virtual links between communication ports of the switch, as well as traffic control information for each virtual link (in particular the maximum size of the frames, the minimum temporal separation between two frames, also called BAG standing for “Bandwidth Allocation Gap”, etc.). The configuration of each switch is downloaded into the latter before its use.

FIG. 1 shows an example of a communication network 20 comprising a set of subscribers 10a, 10b . . . 10g connected to two switches sw1 and sw2. These subscribers can for example correspond to computers of the aircraft. They can be disposed in an avionics bay 2, situated in the vicinity of the cockpit 3 of the aircraft 1, as shown in FIG. 7. The switch sw1 comprises 6 communication ports P1.1 . . . P1.6 as shown in a more detailed way in FIG. 3. The switch sw2 comprises 3 communication ports P2.1, P2.2, P2.3 as shown in a more detailed way in FIG. 5. Two virtual links are shown in FIG. 1: a virtual link VL1 transmitted by the subscriber 10c to the subscribers 10b and 10e and a virtual link VL2 transmitted by the subscriber 10f to the subscriber 10b. The corresponding switching information for the switch sw1 is represented in FIG. 4a: the first column (VL) corresponds to a virtual link identifier, the second column (Pin) corresponds to the port of reception of the virtual link by the switch and the third column (Pout) corresponds to a port of transmission of the virtual link by the switch. The first line makes it possible to define that the virtual link VL1 is received through the port P1.1 (coming from the subscriber 10c) and retransmitted through the port P1.3 (to the subscriber 10b). The second line makes it possible to define that this same virtual link VL1 received through port P1.1 is retransmitted through the P1.5 (to the subscriber 10e). The third line makes it possible to define that the virtual link VL2 is received through the port P1.6 (coming from the switch sw2) and retransmitted though the port P1.3 (to the subscriber 10b). FIG. 6a is similar to FIG. 4a for the switch sw2. The single line makes it possible to define that the virtual link VL2 is received through the port P2.2 (coming from the subscriber 10f) and retransmitted through the P2.1 (to the switch sw1).

Certain equipment that are subscribers to the communication network have the function of receiving information coming from other subscriber equipment in order to make this information available to a user in order to facilitate the maintenance of the aircraft. Thus, for example, a modern aircraft generally comprises a central maintenance computer, generally called CMC (standing for “Central Maintenance Computer”) or CMS (standing for “Central Maintenance System”), as well as an ACMS (standing for “Aircraft Condition Monitoring System”) system. However, such equipment are configured for receiving only certain specific information. Now, among the other information exchanged between the different equipment subscribing to the communication network, some items of information could be useful to a maintenance operator of the aircraft.

### SUMMARY

A purpose of the present disclosure is notably to provide a solution to these problems. It relates to an onboard communication network of an aircraft, the communication network being a deterministic switched Ethernet network comprising:
a set of subscribers; and
at least one switch, the communication network using virtual links, each defined between a transmitting subscriber and one or more receiving subscribers,

This network is noteworthy in that:
the at least one switch comprises a communication port configured for communicating with at least one equipment external to the aircraft; and
the communication network is configured in such a way that at least one of the virtual links is transmitted though this communication port so as to transmit the information exchanged between subscribers to the network to the equipment external to the aircraft by the virtual link.

Thus, the equipment external to the aircraft can receive information exchanged inside the aircraft between equipment subscribed to the communication network. The information transmitted to the outside equipment is a function solely of the configuration of the communication network, no modification of the equipment subscribing to the network being necessary in order to do this.

According to particular embodiments which can be taken into account individually or in combination:
the communication network is moreover configured in such a way that no virtual link is configured, in a configuration table of the switch, from the communication port of the switch to another communication port of the switch. This makes it possible not to accept data frames through this communication port in order to avoid interference with the communication network of the aircraft, or with the equipment subscribing to that network, by an equipment external to the aircraft;
the subscribers of the set of subscribers as well as the at least one switch are configured for communicating on the communication network according to a communication protocol compatible with the ARINC 664 part 7 standard;
the switch comprises a configuration table configurable as a function of virtual links passing through this switch, this configuration table being configured in such a way that the communication port is the transmitter of the at least one virtual link;
the communication network comprises a wireless transmitter connected to the communication port.

The disclosure herein also relates to a communication system comprising a communication network such as mentioned above and a device external to the aircraft able to receive, from the communication port, the information exchanged between equipment of the aircraft by the virtual link.

Advantageously, the device external to the aircraft comprises a man-machine interface, a viewer, a processor and software configured for recording, in a memory of the device, at least a portion of the information received from the communication network and for producing a display on the viewer as a function of the information and of interactions of a user with the man-machine interface.

In one embodiment, when the communication network comprises a wireless transmitter connected to the communication port of the switch, the communication system comprises at least two devices external to the aircraft. This makes it possible for several maintenance operators to work on the aircraft simultaneously, each one using one of the external devices.

The disclosure herein also relates to an aircraft comprising a communication network such as mentioned above.

### BRIEF DESCRIPTION OF THE DRAWINGS

The disclosure herein will be better understood on reading the following description and on examining the appended figures.

FIG. 1, already described, shows an onboard communication network of an aircraft.

FIG. 2 shows an onboard communication network of an aircraft, according to one embodiment of the disclosure herein.

FIGS. 3 and 5 show switches of the communication networks shown in FIGS. 1 and 2.

FIGS. 4a and 6a show configuration tables of the switches of the communication network shown in FIG. 1.

FIGS. 4b and 6b show configuration tables of the switches of the communication network shown in FIG. 2.

FIG. 7 shows an aircraft comprising a communication network.

### DETAILED DESCRIPTION

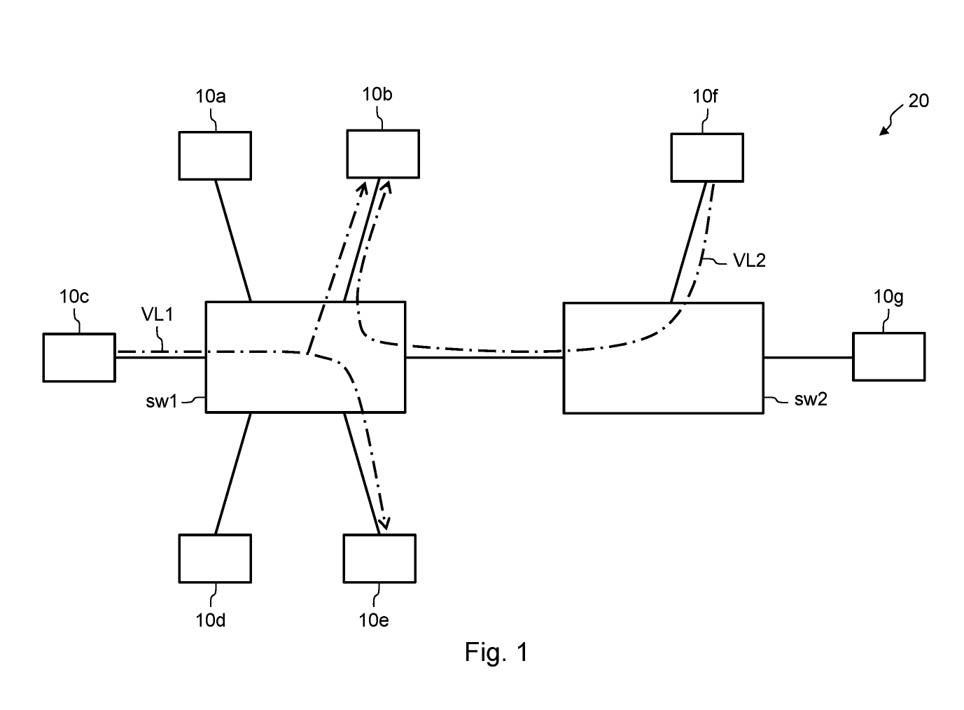

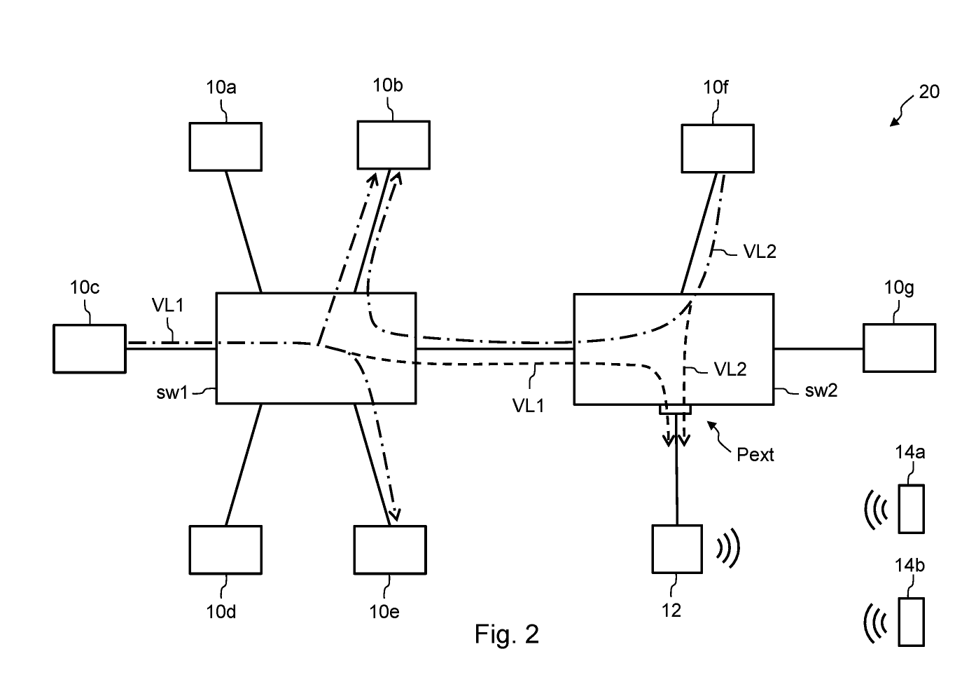

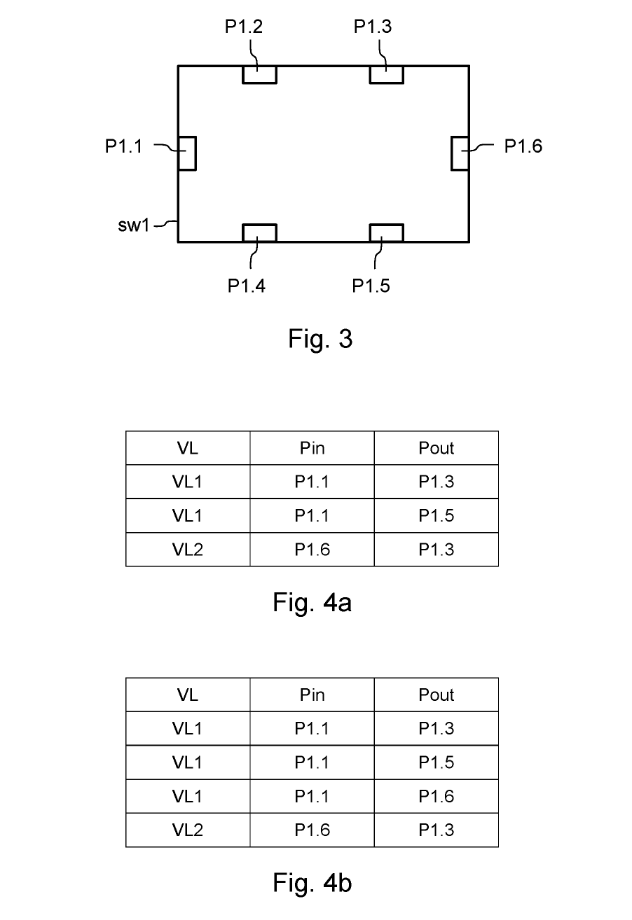

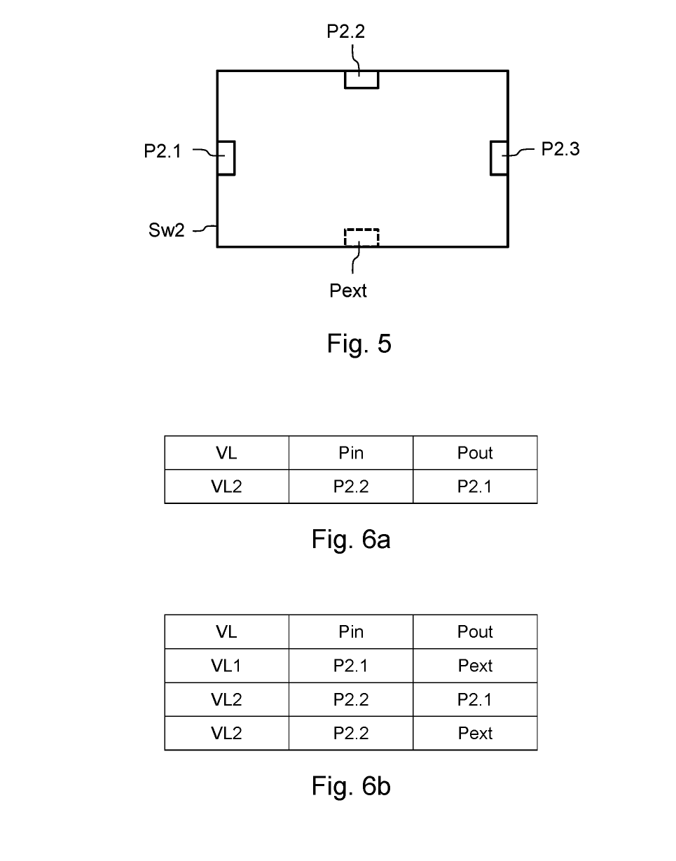

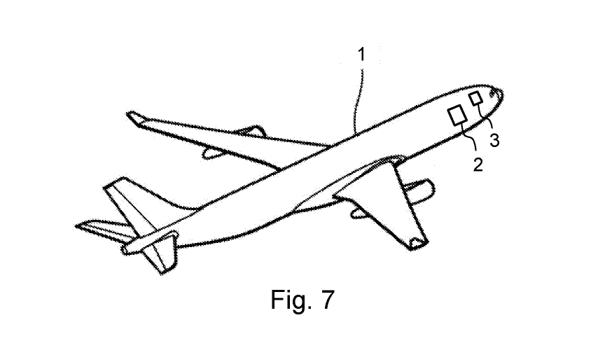

The communication network 20 shown in FIG. 2 is similar to the one, already described, shown in FIG. 1. However, the switch sw2 comprises moreover a communication port Pext configured for communicating with at least one equipment external to the aircraft. The expression “external to the aircraft” in this case denotes equipment which is not part of the aircraft, this equipment being able to be located just as well inside as outside of the fuselage of the aircraft. The two virtual links VL1 and VL2 are modified in such a way that the communication port Pext transmits the data frames corresponding to these virtual links. Thus, the virtual link VL1 is moreover transmitted, through the communication port P1.6 of the switch sw1, to the communication port P2.1 if the switch sw2. The configuration tables of the switches are consequently modified: FIGS. 4b and 6b correspond to the switching information, respectfully modified in comparison with FIGS. 4a and 6a. Thus, in FIG. 4b, a third line is added in order to define that the virtual link VL1 received through the port P1.1 is retransmitted through the port P1.6 (to the switch sw2). In FIG. 6b, the first line is added in order to define that the virtual link VL1 is received through the port P2.1 (coming from the switch sw1) and retransmitted through the port Pext. The third line is added in order to define that the virtual link VL2 received through the port P2.2 is retransmitted through the port Pext. Thus, the data frames transmitted on the virtual links VL1 and VL2, respectively by the subscribers 10c and 10f, are retransmitted through the communication port Pext of the switch sw2 to the equipment external to the aircraft.

In a particular embodiment shown in FIG. 2, equipment 12 is connected to the communication port Pext of the switch sw2. This equipment 12 is a wireless transmitter, using for example the Wifi technology. Equipment external to the aircraft 14a, 14b, for example smartphones or tablets used by maintenance operators of the aircraft can thus receive the data frames corresponding to the virtual links VL1 and VL2 transmitted by the wireless transmitter 12. The operators can thus display on these equipment 14a, 14b information carried by the data frames, in order to facilitate their maintenance of the aircraft operations.

In another particular embodiment, not shown, a network connector (for example an RJ45 standard connector) is connected to the communication port Pext. Equipment external to the aircraft can then be connected to this connector in order to receive the data frames corresponding to the virtual links VL1 and VL2.

Advantageously, the device external to the aircraft comprises a viewer such as for example a touch screen, a man-machine interface such as for example a touch sensitive area of the touch screen, a processor and software configured for recording, in a memory of the device, at least a portion of the information received from the communication network and for producing a display on the viewer as a function of the information and of interactions of a user with the man-machine interface. According to a first variant, the software is configured in such a way as to make it possible for the user to select the information that he wishes to display and for recording only the information in the memory. According to a first alternative, the software is configured for recording in the memory only current values of the information and the user can then display solely this current information. According to a second alternative, the software is configured for recording in the memory a history of the values of the information and the user can then equally well display the current values and the history of the information. According to a second variant, the software is configured for recording in the memory a predefined set of information from among the information received from the communication network. This predefined set of information can for example correspond to a particular system of the aircraft for which the user is responsible for maintenance. As in the first variant, the recording in the memory can correspond either to the current values of the information, or to a history of the latter. According to a third variant, the software is configured in such a way as to record in the memory all of the information received from the communication network. The user can thus consult all of the information either simultaneously, or by browsing in different display pages available on the viewer. As in the preceding variants, the recording in the memory can correspond either to current values of the information or to a history of the latter.

Advantageously, the communication network is configured in such a way as not to accept the reception of data frames through the port Pext. In order to do this, no virtual link is configured, in the configuration tables of the switches, from the port Pext to another communication port. This makes it possible to avoid interference with the communication network of the aircraft, or with the equipment subscribing to that network, by equipment external to the aircraft.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An onboard communication network of an aircraft, the communication network being a deterministic switched Ethernet network comprising:
a set of subscribers corresponding to computers of the aircraft; and
at least one switch,
the communication network using virtual links, each defined between a transmitting subscriber and one or more receiving subscribers of the set of subscribers,
wherein:
the at least one switch comprises a communication port configured for communicating with at least one equipment external to the aircraft; and
the communication network is configured such that at least one of the virtual links is transmitted though this communication port so as to transmit information exchanged between subscribers to the network to the equipment external to the aircraft by the virtual link.

2. The communication network a claimed in claim 1, configured such that no virtual link is configured, in a configuration table of the at least one switch, from the communication port of the switch to another communication port of the switch.

3. The communication network as claimed in claims 1, wherein the subscribers of the set of subscribers as well as the at least one switch are configured for communicating on the communication network according to a communication protocol compatible with the ARINC 664 part 7 standard.

4. The communication network as claimed in claim 1, wherein the switch comprises a configuration table configurable as a function of virtual links passing through this switch, this configuration table being configured such that the communication port is a transmitter of the at least one virtual link.

5. The communication network as claimed in claim 1, comprising a wireless transmitter connected to the communication port.

6. A communication system comprising a communication network as claimed in claim 1 and a device external to the aircraft able to receive, from the communication port, information exchanged between equipment of the aircraft by the virtual link.

7. The communication system as claimed in claim 6, wherein the device external to the aircraft comprises a man-machine interface, a viewer, a processor and software configured for recording, in a memory of the device, at least a portion of the information received from the communication network and for producing a display on the viewer as a function of the information and of interactions of a user with the man-machine interface.

8. The communication system as claimed in claim 1, comprising:
a wireless transmitter connected to the communication port;
a device external to the aircraft configured to receive, from the communication port, information exchanged between equipment of the aircraft by the virtual link; and
comprising at least two devices external to the aircraft.

9. An aircraft comprising a communication network, the communication network comprising:
an onboard communication network of an aircraft, the communication network being a deterministic switched Ethernet network comprising:
a set of subscribers corresponding to computers of the aircraft; and
at least one switch,
the communication network using virtual links, each defined between a transmitting subscriber and one or more receiving subscribers of the set of subscribers,
wherein:
the at least one switch comprises a communication port configured for communicating with at least one equipment external to the aircraft; and
the communication network is configured such that at least one of the virtual links is transmitted though this communication port so as to transmit information exchanged between subscribers to the network to the equipment external to the aircraft by the virtual link.
